(19) United States
(12) Patent Application Publication
(10) Pub. No.: US 2024/0192447 A1
(43) Pub. Date: Jun. 13, 2024

(54) OPTICAL MULTIPLEXER

(71) Applicant: SEIREN KST Corp., Fukui (JP)

(72) Inventors: Akira HIMENO, Fukui (JP); Koichi HORII, Fukui (JP); Osamu KAWASAKI, Fukui (JP); Kazuki IWABATA, Fukui (JP); Yuuta YABE, Fukui (JP); Yojiro KAMEI, Fukui (JP)

(73) Assignee: SEIREN KST Corp., Fukui (JP)

(21) Appl. No.: 18/288,080

(22) PCT Filed: Apr. 11, 2022
(86) PCT No.: PCT/JP2022/017494

§ 371 Date: Oct. 24, 2023

(30) Foreign Application Priority Data
Apr. 28, 2021 (JP) 2021-075688

(51) Int. Cl. G02B 6/293

(52) U.S. Cl. CPC G02B 6/2938; G02B 6/29352

(57) ABSTRACT

The present invention provides an optical multiplexer that includes waveguides forming an asymmetric shape with respect to the light traveling direction and can work as designed even when it is obtained through a heat treatment.

The optical multiplexer includes at least three input optical waveguides, at least two directional couplers, and at least one output optical waveguide such that the waveguides including the input optical waveguides form an asymmetric shape with respect to a light traveling direction. The optical multiplexer further includes at least one dummy waveguide that is in a horizontally flipped shape of a waveguide located asymmetrically with respect to a center line of the directional couplers or a Mach-Zehnder interferometer composed of a combination of two of the directional couplers. Thus, a waveguide in a light coupling section of each of the directional couplers is prevented from falling inward.

### TECHNICAL FIELD

The present invention relates to an optical multiplexer including at least three input optical waveguides, at least one output optical waveguide, and further a dummy waveguide that does not function as a waveguide.

### BACKGROUND ART

In recent years, it has been known to use an optical multiplexer in synthetic light generation devices, which are employed as a light source for image projection devices such as an eye-wear and a portable projector. The optical multiplexer multiplexes light from a plurality of laser diodes as light sources through waveguides and outputs the multiplexed light (see Patent Document 1.) Such an optical multiplexer is produced through the following steps: forming a low refractive index silicon oxide layer and a high refractive index silicon oxide layer on a silicon substrate by a known method such as chemical vapor deposition (CVD) or sputtering; patterning the high refractive index silicon oxide layer into waveguides and directional couplers by photolithography using a photomask; and over-cladding another low refractive index silicon oxide layer.

In the step of over-cladding another low refractive index silicon oxide layer after the formation of the waveguides, there are cases where low refractive index silicon oxide fails to densely fill the inside of a light coupling section where two waveguides of each of the directional couplers are located close to each other. In such cases, these two waveguides in the light coupling section fall inward symmetrically in a heat treatment step, which follows the aforementioned step of over-cladding the low refractive index silicon oxide layer, for making the low refractive index silicon oxide layer transparent. This can lead to a product failure in which light cannot be coupled as designed. In order to prevent such a product failure, it has been known to provide, for example, dummy waveguides, which are quasi-waveguides not intended to function as an optical waveguide, symmetrically on the outer sides of the light coupling section (see Patent Documents 2 and 3.)

However, the optical multiplexer for use in synthetic light generation devices to be employed as a light source for the image projection devices as mentioned above is designed to be small. As such, at least two directional couplers are provided close to each other. In addition, the waveguides including an input optical waveguide form an asymmetric shape with respect to the light traveling direction, which makes it highly likely that the two waveguides in the light coupling section fall inward asymmetrically. Such an asymmetric fall cannot be fully addressed by simply providing dummy waveguides symmetrically on the outer sides of the light coupling section. For this reason, it sometimes becomes difficult to obtain an optical multiplexer that works as designed.

### PRIOR ART DOCUMENTS

### Patent Documents

Patent Document 1: JP-A-2013-195603
Patent Document 2: JP-A-5-093813
Patent Document 3: JP-A-2012-022273

### SUMMARY OF THE INVENTION

### Problems to be Solved by the Invention

The present invention has been made in view of the aforementioned circumstances and provides an optical multiplexer that includes waveguides forming an asymmetric shape with respect to the light traveling direction and can work as designed even when it is obtained through a heat treatment.

### Means for Solving the Problems

The present invention provides an optical multiplexer including at least three input optical waveguides, at least two directional couplers, and at least one output optical waveguide such that the waveguides including the input optical waveguides form an asymmetric shape with respect to a light traveling direction. The optical multiplexer further includes at least one dummy waveguide that is in a horizontally flipped shape of a waveguide located asymmetrically with respect to a center line of the directional couplers or a Mach-Zehnder interferometer composed of a combination of two of the directional couplers.

The dummy waveguide as used herein is a quasi-waveguide not intended to function as an optical waveguide and is in the horizontally flipped shape of the waveguide located asymmetrically with respect to the center line of the directional couplers or the Mach-Zehnder interferometer. In order to prevent a waveguide in a light coupling section of each of the directional couplers from falling inward, the dummy waveguide is provided on the outer side of the waveguide in the light coupling section opposite to the center line and is formed of the same material and at the same time as the waveguide. The distance of the dummy waveguide from the center line is set such that the dummy waveguide and the asymmetrically located waveguide are symmetric with respect to the center line, or such that it is larger than the distance at which the dummy waveguide and the asymmetrically located waveguide are symmetric.

The degree of inward fall of the optical waveguide in the light coupling section is not fixed and differs depending on the circumstances such as the design and manufacturing condition of the optical multiplexer. When the degree of fall is maximum, the distance of the dummy waveguide from the center line is desirably such that the dummy waveguide and the asymmetrically located waveguide are symmetric with respect to the center line. On the other hand, when the degree of fall is small, the dummy waveguide located at the aforementioned distance becomes too effective in preventing fall and causes the waveguide to fall to the dummy waveguide side on the contrary, which can lead to difficulty in coupling light. On this account, it is necessary to make the distance of the dummy waveguide from the center line larger than the distance at which the dummy waveguide and the asymmetrically located waveguide are symmetric, depending on the degree of inward fall, thereby adjusting the fall prevention effect. Here, the larger the distance of the dummy waveguide from the center line, the less the fall prevention effect.

It is preferable that the dummy waveguide in the horizontally flipped shape is partially omitted.

Here, the dummy waveguide in the horizontally flipped shape is partially omitted such that a part of the dummy waveguide corresponding to a region where almost no inward fall of a waveguide occurs is omitted depending on the circumstances such as the design and manufacturing condition of the optical multiplexer.

It is preferable that a distance of the dummy waveguide from the center line of the directional couplers or the Mach-Zehnder interferometer is not less than 1 time and not more than 2.5 times a distance at which the dummy waveguide and the waveguide located asymmetrically with respect to the center line are symmetric. If the distance is less than 1 time, the effect of preventing inward fall of the waveguide is successfully achieved; however, unwanted light coupling can occur between the waveguide and the dummy waveguide as they are located close to each other, which may lead to degradation of multiplexing property. If the distance is more than 2.5 times, the dummy waveguide has almost no effect on the prevention of inward fall of the waveguide in the light coupling section.

It is preferable that light input to the at least three input optical waveguides includes at least red light, green light, and blue light.

It is preferable that the directional couplers are three in number.

It is preferable that the directional couplers are two in number.

The present invention preferably relates to an image projection device using the above-described optical multiplexer.

### Effect of the Invention

The present invention relates to an optical multiplexer including at least three input optical waveguides, at least two directional couplers, and at least one output optical waveguide such that the waveguides including the input optical waveguides form an asymmetric shape with respect to a light traveling direction. The optical multiplexer further includes at least one dummy waveguide that is in a horizontally flipped shape of a waveguide located asymmetrically with respect to a center line of the directional couplers or a Mach-Zehnder interferometer composed of a combination of two of the directional couplers. Thus, in a light coupling section of each of the directional couplers where two waveguides are located close to each other, a waveguide is prevented from falling inward, thereby allowing the optical multiplexer to work as designed. As a result, good product rate is improved and, accordingly, production costs are reduced.

### BRIEF DESCRIPTION OF THE DRAWINGS

FIG. 1: a top view of an optical multiplexer of Example 1;

FIG. 2: X-Y cross-sectional views of the optical multiplexer of Example 1;

FIG. 3: A-B cross-sectional views of the optical multiplexer of Example 1;

FIG. 4: top views of optical multiplexers of Examples 2 to 4;

FIG. 5: a top view of a directional coupler of Conventional Example 1; and

FIG. 6: Q-R cross-sectional views of the directional coupler of Conventional Example 1.

### MODE FOR CARRYING OUT THE INVENTION

Hereinafter, Examples for carrying out the present invention will be described with reference to the drawings. The present invention is not limited to these examples.

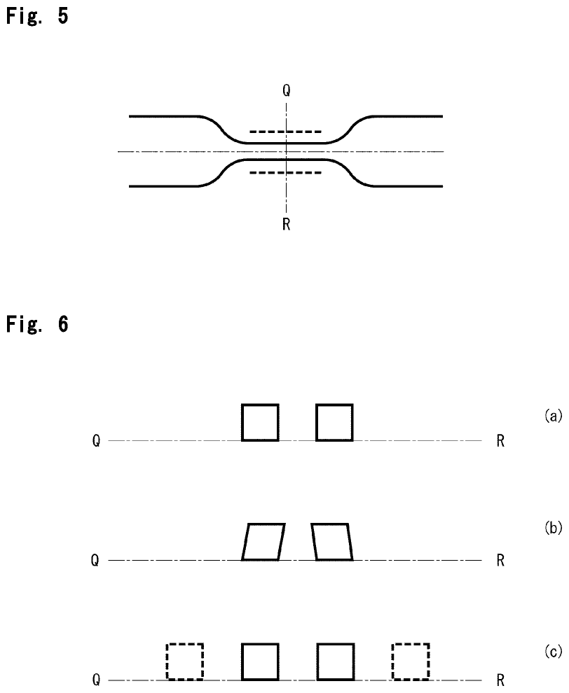

FIG. 5 is a top view of a directional coupler of Conventional Example 1 in which dummy waveguides are provided symmetrically on the outer sides of a light coupling section as described in Patent Document 2. The solid line represents an optical waveguide, and the broken line represents a dummy waveguide.

FIG. 6 shows Q-R cross sections of the directional coupler of Conventional Example 1 shown in FIG. 5. FIG. 6(a) shows the waveguides that form an ideal shape in terms of design. FIG. 6(b) shows the waveguides after a heat treatment step in a case where no dummy waveguide is provided and the light coupling section is not densely filled with silicon oxide. The two waveguides in the light coupling section fall inward, so that light cannot be coupled as designed. FIG. 6(c) shows the waveguides as in FIG. 6(b) and the dummy waveguides provided on the outer sides of the two waveguides in the light coupling section. The dummy waveguides prevent the two waveguides from falling inward, so that light can be coupled as designed.

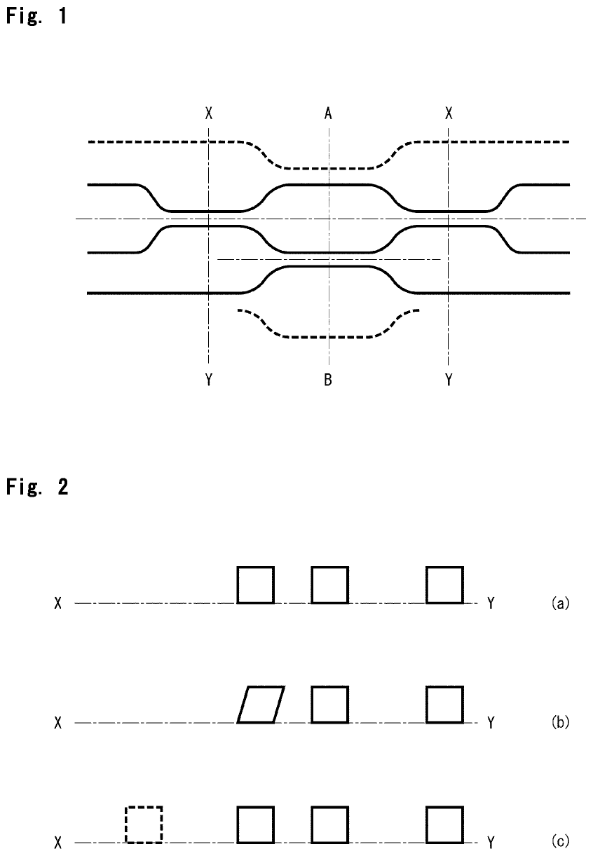

FIG. 1 is a top view of an optical multiplexer of Example 1. The optical multiplexer includes a Mach-Zehnder interferometer composed of a combination of two tandem directional couplers (referred to as a first directional coupler and a second directional coupler from the left) in its upper part, and a further directional coupler (referred to as a third directional coupler) that uses a lower waveguide between the two directional couplers of the Mach-Zehnder interferometer as an optical coupling waveguide. Three light beams of different wavelengths are input respectively to three input optical waveguides on the left side and multiplexed by the Mach-Zehnder interferometer and the third directional coupler, and the multiplexed light is output from the central waveguide of three output optical waveguides on the right side.

The multiplexed light can be output from any of the three output optical waveguides according to the design of the optical multiplexer such as the length and position of the directional couplers and the like. The output optical waveguides from which the multiplexed light is not output may be terminated in the multiplexer because only a small amount of light is output therefrom. In that case, light from such terminations is desirably output in a different direction from the multiplexed light so as not to affect the output of the multiplexed light.

In the optical multiplexer of Example 1 shown in FIG. 1, the waveguides form an asymmetric shape with respect to the light traveling direction. Further, the optical multiplexer includes dummy waveguides that are in the horizontally flipped shapes of waveguides located asymmetrically with respect to the center line of the Mach-Zehnder interferometer and the center line of the third directional coupler, respectively, as described below.

The optical multiplexer includes in its uppermost part the dummy waveguide (broken line) that is in the horizontally flipped shape of the lower waveguide of the third directional coupler located asymmetrically with respect to the dashed-dotted center line of the Mach-Zehnder interferometer.

Further, the optical multiplexer includes in its lowermost part the dummy waveguide (broken line) that is in the horizontally flipped shape of the upper waveguide between the two directional couplers of the Mach-Zehnder interferometer that is located asymmetrically with respect to the dashed-dotted center line of the third directional coupler. The dummy waveguide corresponding to the third directional coupler may be formed only of a straight section and curved sections or simply of the straight section.

FIG. 2 shows X-Y cross sections of the optical multiplexer shown in FIG. 1 including the dummy waveguide in the horizontally flipped shape of the waveguide located asymmetrically with respect to the center line of the Mach-Zehnder interferometer. FIG. 2(a) shows the waveguides that form an ideal shape in terms of design. FIG. 2(b) shows the waveguides after a heat treatment step in a case where no dummy waveguide is provided and a light coupling section is not densely filled with silicon oxide. The right waveguide in the light coupling section is prevented from falling to the inward side of the light coupling section by the asymmetrically located waveguide provided on the outer side to the further right. Meanwhile, the left waveguide in the light coupling section falls to the inward side of the light coupling section. As such, the two waveguides in the light coupling section form an asymmetric shape, so that light cannot be coupled as designed. FIG. 2(c) shows the waveguides as in FIG. 2(b) and the dummy waveguide. The dummy waveguide, which is in the horizontally flipped shape of the asymmetrically located waveguide with respect to the center line of the light coupling section, is provided on the outer side to the further left of the left waveguide in the light coupling section such that the dummy waveguide and the asymmetrically located waveguide are symmetric with respect to the center line. Thus, the left waveguide in the light coupling section is prevented from falling inward, so that the two waveguides in the light coupling section form a symmetric shape. As a result, light can be coupled as designed.

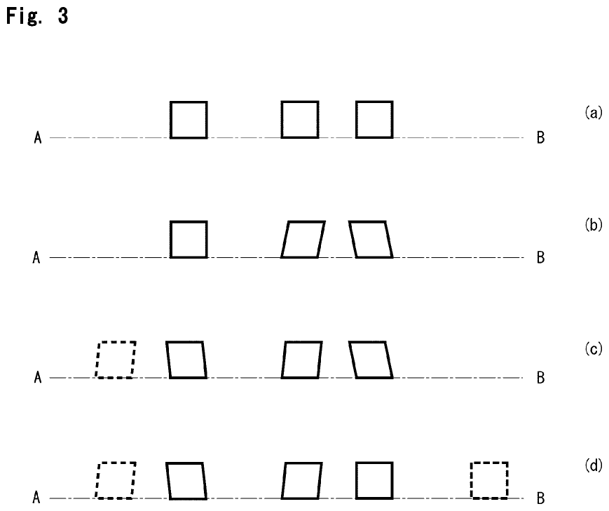

FIG. 3 shows A-B cross sections of the optical multiplexer shown in FIG. 1 including the two dummy waveguides, i.e., the dummy waveguide in the horizontally flipped shape of the waveguide that is located asymmetrically with respect to the center line of the Mach-Zehnder interferometer, and the dummy waveguide in the horizontally flipped shape of the waveguide that is located asymmetrically with respect to the center line of the third directional coupler. Here, the right waveguide in the Mach-Zehnder interferometer doubles as the left waveguide in the light coupling section of the third directional coupler. FIG. 3(a) shows the waveguides that form an ideal shape in terms of design. FIG. 3(b) shows the waveguides after a heat treatment step in a case where no dummy waveguide is provided and the light coupling section is not densely filled with silicon oxide. Both of the two waveguides in the light coupling section of the third directional coupler fall inward, despite the presence of the waveguide provided to the left of the left waveguide in the light coupling section. Thus, light cannot be coupled as designed. Further, the two waveguides in the Mach-Zehnder interferometer are asymmetric, which can lead to property degradation. FIG. 3(c) shows the waveguides as in FIG. 3(b) and the dummy waveguide in the horizontally flipped shape of the right waveguide in the light coupling section of the third directional coupler that is located asymmetrically with respect to the center line of the Mach-Zehnder interferometer. The two waveguides in the Mach-Zehnder interferometer fall symmetrically, thereby reducing property degradation. Here, the left waveguide in the light coupling section of the third directional coupler, which doubles as the right waveguide of the Mach-Zehnder interferometer, falls to a smaller degree. Thus, the two waveguides in the light coupling section form an asymmetric shape. FIG. 3(d) shows the waveguides and the dummy waveguide as in FIG. 3(c) and further the dummy waveguide in the horizontally flipped shape of the left waveguide of the Mach-Zehnder interferometer that is located asymmetrically with respect to the center line of the third directional coupler. The dummy waveguide is provided on the outer side to the further right of the right waveguide in the light coupling section, thereby preventing the right waveguide in the light coupling section from falling.

In FIG. 3(d), the left dummy waveguide is in the horizontally flipped shape of the waveguide that is located asymmetrically with respect to the center line of the Mach-Zehnder interferometer, and the right dummy waveguide is in the horizontally flipped shape of the waveguide that is located asymmetrically with respect to the center line of the third directional coupler. The two dummy waveguides provided on the right and left sides, respectively, serve to reduce fall of the two waveguides in the light coupling section of the third directional coupler. Thus, light can be coupled as designed.

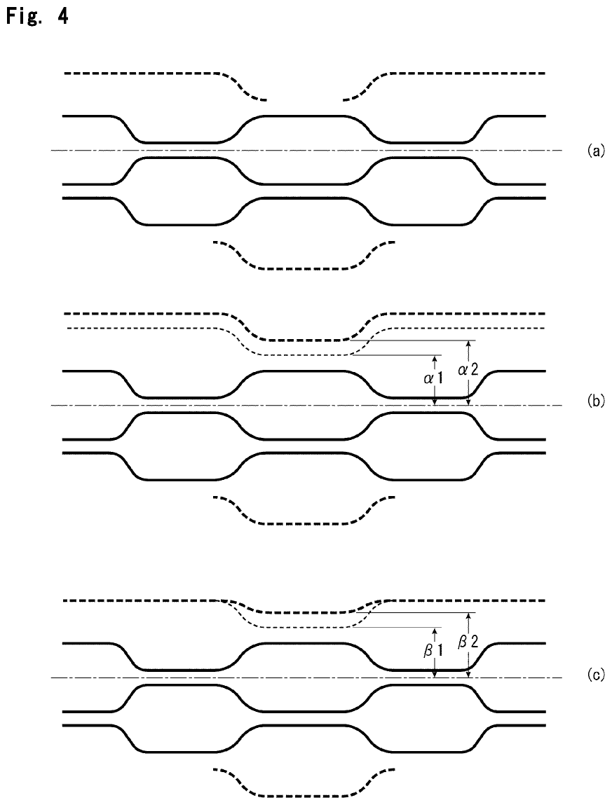

FIG. 4(a) is a top view of an optical multiplexer of Example 2. In Example 2, the dummy waveguide corresponding to the center line of the Mach-Zehnder interferometer in Example 1 is partially omitted. Specifically, the straight section of the dummy waveguide located closest to the Mach-Zehnder interferometer is omitted. In this omitted straight section, unwanted light coupling between the dummy waveguide and the Mach-Zehnder interferometer never occurs, thereby excluding the possibility that multiplexing property is degraded by such unwanted light coupling. Although the dummy waveguide becomes less effective in preventing fall of the waveguide in the omitted section, it remains effective in other parts than the omitted section. In this manner, when multiplexing property needs to be prioritized over the effect of the dummy waveguide, the dummy waveguide can be partially omitted depending on the circumstances such as the design and manufacturing condition of the optical multiplexer.

FIG. 4(b) is a top view of an optical multiplexer of Example 3. In Example 3, the dummy waveguide in Example 1, which is located at a distance of α1 from the center line of the Mach-Zehnder interferometer where the dummy waveguide and the waveguide located asymmetrically with respect to the center line are symmetric, is entirely displaced to a distance of a2 from the center line of the Mach-Zehnder interferometer. In other words, the distance of the entire dummy waveguide from the center line is increased by “α2/α1” times, with the following condition satisfied: 1≤α2/α≤2.5.

FIG. 4(c) is a top view of an optical multiplexer of Example 4. In Example 4, the dummy waveguide in Example 1, which is located at a distance of β1 from the center line of the Mach-Zehnder interferometer where the dummy waveguide and the waveguide located asymmetrically with respect to the center line are symmetric, is partially displaced in parallel to a distance of β2 from the center line of the Mach-Zehnder interferometer. In other words, the distance of the displaced part of the dummy waveguide from the center line is increased by “β2/β1” times, with the following condition satisfied: 1≤β2/β1≤2.5.

1. An optical multiplexer comprising at least three input optical waveguides, at least two directional couplers, and at least one output optical waveguide such that the waveguides including the input optical waveguides form an asymmetric shape with respect to a light traveling direction, the optical multiplexer further comprising at least one dummy waveguide that is in a horizontally flipped shape of a waveguide located asymmetrically with respect to a center line of the directional couplers or a Mach-Zehnder interferometer composed of a combination of two of the directional couplers.

2. The optical multiplexer according to claim 1, wherein the dummy waveguide in the horizontally flipped shape is partially omitted.

3. The optical multiplexer according to claim 2, wherein a distance of the dummy waveguide from the center line of the directional couplers or the Mach-Zehnder interferometer is not less than 1 time and not more than 2.5 times a distance at which the dummy waveguide and the waveguide located asymmetrically with respect to the center line are symmetric.

4. The optical multiplexer according to claim 1, wherein light input to the at least three input optical waveguides includes at least red light, green light, and blue light.

5. The optical multiplexer according to claim 1, wherein the directional couplers are three in number.

6. The optical multiplexer according to claim 1, wherein the directional couplers are two in number.

7. An image projection device using the optical multiplexer according to claim 1.
